(19) United States
(12) Patent Application Publication
(10) Pub. No.: US 2012/0267479 A1
(43) Pub. Date: Oct. 25, 2012

(54) METHOD FOR THE PRODUCTION OF A COMPOSITE TRAILING EDGE PANEL FOR AN AIRCRAFT ELEMENT

(75) Inventors: Denis Millepied, Magny-les-hameaux (FR); Jean-Luc Pacary, Meudon La Foret (FR); Arnaud Bertrand, Ecquevilly (FR); Valerian Montagne, Paris (FR)

(73) Assignee: SOCIETE LORRAINE DE CONSTRUCTION AERONAUTIQUE, Florange (FR)

(21) Appl. No.: 13/516,770

(22) PCT Filed: Dec. 14, 2010
(86) PCT No.: PCT/FR2010/052729

§ 371 Date: Jun. 18, 2012

(30) Foreign Application Priority Data
Dec. 18, 2009 (FR) 09/06157

(51) Int. Cl. B64C 3/20; B21D 53/88

(52) U.S. Cl. 244/123.3; 29/897.2; 244/132

(57) ABSTRACT

The invention relates to a method for producing a structural composite trailing edge panel (1) for an aircraft element having: an upper surface (3), a lower surface (5), and a trailing edge (7) connecting said upper (3) and lower (5) surfaces, the upper surface (3) and the lower surface (5) being connected by transverse stiffeners (9), at least one longitudinal spar (10) being positioned in such a way that the directrix (Δ₁₀) of each longitudinal spar (10) and the directrix (Δ₉) of the transverse stiffeners (9) are not collinear and the structuring panel (1) being made up of a one-piece component forming the upper surface (3), the lower surface (5), the trailing edge (7), the transverse stiffeners (9) and the spar or spars (10).

### TECHNICAL FIELD

The present invention relates to a structural composite trailing edge panel for an aircraft element.

The invention also relates to an aircraft element comprising such a panel.

### BRIEF DISCUSSION OF RELATED ART

Composite panels are panels frequently used in the aerospace industry, as they make it possible to lighten the aircraft considerably.

Certain aircraft parts require structural panels providing good mechanical strength. These in particular include trailing edges, like those of airplane control surfaces.

Composite structural panels of the sandwich type are commonly used, including a cellular core structure placed between an inner skin and an outer skin.

Typically, the inner skin and the outer skin are each made up of one or more fibrous plies preimpregnated with resin, which is then polymerized during the curing step.

Other methods used dry fibrous plies, i.e. not preimpregnated with resin, the resin being applied later during a curing step during which it is forced to diffuse between the fibrous plies by suction.

A composite sandwich panel can also comprise several central layers, of the same type or different types, the central layers in turn being able to be separated by a layer of composite material.

The central layers can for example be of the cellular or foam type, or can comprise one or more fusible inserts.

Composite sandwich panels using a honeycomb or foam core structure, for example, help reduce the mass of the objects while preserving or increasing the mechanical properties thereof.

However, these types of panels are generally not adapted to the manufacture of trailing edges.

In order to resolve this problem, in application FR09/02579, a structural composite trailing edge panel for an aircraft element is proposed having an upper surface, a lower surface, and an edge connecting said upper and lower surfaces.

The upper surface and the lower surface are connected by transverse stiffeners.

The structural panel is made up of an integral piece forming the upper surface, the lower surface, the trailing edge, and the transverse stiffeners.

Despite the advantages such a panel procures, it may be desirable to still further limit the buckling of the upper and lower skins while guaranteeing good stiffness in flexure and torsion.

### BRIEF SUMMARY

One aim of the present invention is therefore to provide a panel making it possible to limit the buckling of the upper and lower skins and to improve the structural mechanical strength while being simple to produce.

To that end, according to a first aspect, the invention relates to a structural composite trailing edge panel for an aircraft element having:
an upper surface,
a lower surface, and
a trailing edge connecting said upper and lower surfaces,

the upper surface and the lower surface being connected by transverse stiffeners,

characterized in that at least one longitudinal spar is positioned in such a way that the directrix of each longitudinal spar and the directrix of the transverse stiffeners are not collinear and in that the structural panel is made up of an integral component forming the upper surface, the lower surface, the trailing edge, the transverse stiffeners and the spar(s).

“Directrix” refers to the guiding axis of a spar or a transverse stiffener in the largest dimension thereof.

The presence of one or more longitudinal spars arranged substantially perpendicular to the transverse stiffeners makes it possible to limit the buckling of the upper and lower skins and improve the structural mechanical strength of the inventive panel in two substantially perpendicular directions of the panel according to the invention. Furthermore, the panel according to the invention being made completely integrally, it is simple to produce.

Preferably, the directrix of each longitudinal spar and the directrix of the transverse stiffeners are substantially perpendicular.

Preferably, at least one longitudinal spar is positioned between two transverse stiffeners, which makes it possible to locally reinforce the structural strength of the panel according to the invention.

Preferably, the skin forming said panel comprises a plurality of plies, including one or more inner plies forming the longitudinal spar(s).

Preferably, the panel according to the invention comprises reinforcing plies between the inner plies, which makes it possible to reinforce the longitudinal spar(s) and the transverse stiffeners.

According to another aspect, the invention relates to a method for manufacturing a panel according to the invention, in particular a composite trailing edge panel for an aircraft element, characterized in that it comprises:
a first step (A) in which first cores and at least one second core are positioned, each surrounded at least partially by a draping skin on a base skin, in two non-collinear directions, such that said base skin can be folded on itself;
a second step (B) in which the base skin is folded on the first and second draped cores;
a third step (C) in which the panel thus obtained is polymerized so as to integrate the plies of the draping into the base skin to form the transverse stiffeners and the longitudinal spar(s); and
a fourth step (D) in which the first cores and the second core(s) are removed so as to obtain the structural panel.

Preferably, the directrix of each longitudinal spar and the directrix of the transverse stiffeners are substantially perpendicular.

Preferably, at least one longitudinal spar is positioned between two transverse stiffeners.

Preferably, the skin forming said panel comprises a plurality of plies, whereof one or several inner plies form the longitudinal spar(s).

Preferably, the panel comprises reinforcing plies between the inner plies.

Preferably, the second core(s) have a decreasing height along the transverse section of said cores, which allows a good aerodynamic line of the panel according to the invention.

Preferably, each first and second core is draped by a draping skin of the monolithic type having a plurality of plies.

Preferably, in step A, first cores are positioned before the trailing edge so as to form a space between the trailing edge and the first cores, in which space one or more second cores are installed substantially parallel to the trailing edge.

According to still another aspect, the invention relates to an aircraft element comprising at least one structural panel according to the invention or obtained using the method according to the invention.

Preferably, the element according to the invention is an airplane control surface.

### BRIEF DESCRIPTION OF THE DRAWINGS

The invention will be better understood upon reading the following non-limiting description, done in reference to the appended figures.

FIG. 1 is a perspective view of the panel according to the invention,

FIG. 2 is a bottom perspective view of one alternative embodiment of the panel of FIG. 1,

FIG. 3 is an enlarged front view of the embodiment of FIG. 1, and

FIGS. 4 to 6 are perspective views of the method for manufacturing a panel according to the invention.

### DETAILED DESCRIPTION

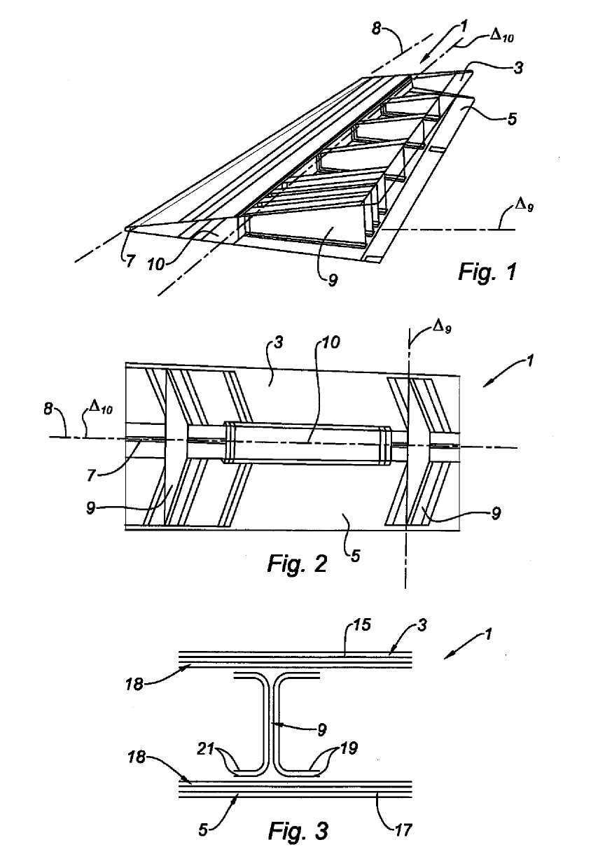

As illustrated in FIG. 1, the panel 1 according to the invention comprises an upper surface 3, a lower surface 5, and an edge 7 connecting the upper 3 and lower 5 surfaces. The panel 1 according to the invention defines a trailing edge 7 directly obtained during curing of the panel 1 according to the invention, which simplifies the manufacture thereof.

The upper surface 3 and the lower surface 5 are connected by transverse stiffeners 9 as well as at least one or more longitudinal spar(s) 10, said stiffeners 9 and said longitudinal spar(s) 10 being integrated into the latter.

At least one longitudinal spar 10 is positioned so that the generatrix Δ₁₀ of each longitudinal spar 10 and the directrix Δ₉ of the transverse stiffeners 9 are not collinear. In this way, advantageously, the panel according to the invention 1 has very good structural strength in two non-parallel directions.

Preferably, the directrix Δ₁₀ of each longitudinal spar 10 and the directrix Δ₉ of the transverse stiffeners 9 are substantially perpendicular.

“Longitudinal” refers to a direction substantially collinear to the directrix 8 of the trailing edge 7. As illustrated in FIGS. 1 and 2, the directrix 8 of the trailing edge can be substantially collinear to the directrix Δ₁₀ of each longitudinal spar 10 and/or substantially perpendicular to the directrix Δ₉ of the transverse stiffeners 9.

According to one alternative not shown, the directrix Δ₉ of the transverse stiffeners 9 may be not collinear to the directrix 8 of the trailing edge without being perpendicular thereto. Likewise, the directrix Δ₁₀ of each longitudinal spar 10 may be not collinear to the directrix 8 of the trailing edge and also not collinear to the directrix Δ₉ of the transverse stiffeners 9.

“Transverse” refers to a direction substantially perpendicular to the planes formed by the upper surface 3 and the lower surface 5.

The longitudinal spar(s) 10 are typically placed at the end of the transverse stiffeners 9 opposite the trailing edge 7. To that end, the transverse stiffeners 9 are placed at a non-zero distance from the trailing edge 7.

The panel 1 according to the invention can thus comprise a single longitudinal spar or, on the contrary, a plurality of longitudinal spars. Using a plurality of spars 10, in particular placed between two transverse stiffeners 9 (see FIG. 2), makes it possible locally to limit any buckling of the panel 1 according to the invention. Said spar 10 then has a length at most equal to the spacing of the two transverse stiffeners 9 along the directrix 8.

Typically, the length of a longitudinal spar 10 along the directrix Δ₁₀ thereof may assume any value less than or equal to the length of the panel 1 according to the invention. In the case where the directrix Δ₁₀ of the longitudinal spar 10 is not substantially parallel to the directrix 8 of the trailing edge, the length of said spar 10 may be greater than the length of the panel 1 according to the invention without said spar 10 protruding past said panel 1.

Likewise, the length of a transverse stiffener 9 along the directrix Δ₉ thereof may assume any value less than or equal to the width of the panel 1 according to the invention. In the case where the directrix Δ₉ of the transverse stiffener 9 is not substantially perpendicular to the directrix 8 of the trailing edge, the length of said stiffener 9 may be greater than the width of the panel 1 according to the invention without said stiffener 9 protruding past said panel 1.

Furthermore, the panel according to the invention 1 is made up of a single integral piece forming the upper surface 3, the lower surface 5, the edge 7, as well as the transverse stiffeners 9 and the spar(s) 10. To that end, the panel 1 according to the invention may be made up of a single monolithic skin.

The monolithic skin may be made from any type of fabrics or fibers adapted and known by those skilled in the art that may be impregnated with an epoxy resin or other substance. To that end, examples include carbon, glass, or Kevlar® fibers.

As illustrated in FIG. 3, the single monolithic skin is made up of a plurality of plies 18 fused on one another by means of a polymerizable resin, such as epoxy resin, positioned between the plies 18.

More specifically, the upper portion 15 of the skin forming the upper surface 3 and the lower portion 17 of the skin forming the lower surface 5 can include a plurality of plies 18 whereof the inner plies 19, 21 positioned towards the inside of the panel 1 can extend continuously along said panel 1 from one straight section to a second straight section. The fact that the transverse stiffeners 9 and spar(s) 10 are made up of plies 18 makes it possible to obtain a very strong structural composite panel 1 to absorb an impact substantially transverse to the upper 3 or lower 5 surface. In fact, the panel 1 according to the invention is advantageously mechanically reinforced in two non-collinear directions, in particular substantially perpendicular, relative to the plane formed by the panel 1 according to the invention.

The inner plies 19 can extend continuously from the lower portion 17, passing through the panel 1 substantially perpendicular to the lower surface 5 while forming a portion of the plies of a transverse stiffener 9 or a spar 10 and before extending at the upper surface 3 again along the straight section.

The same is true for the other inner plies 21 of the other straight section.

In this way, the transverse stiffener 9 and the spar(s) 10 are formed by the inner plies 19 and 21 coming from the straight sections.

Of course, the plies 18 used can be identical or different depending on the desired properties.

Examples of the nature of plies traditionally used include, among others, glass, carbon, and Kevlar fibers.

In the case where the plies 19, 21 participating in the reinforcements are not sufficiently strong by themselves or should be reinforced, all or some of said plies 19, 21 may in particular be bent. It is also possible to insert, between the plies 19, 21, reinforcing plies, such as carbon fiber plies for example, which may be present in the transverse stiffeners 9 and/or the spar(s) 10.

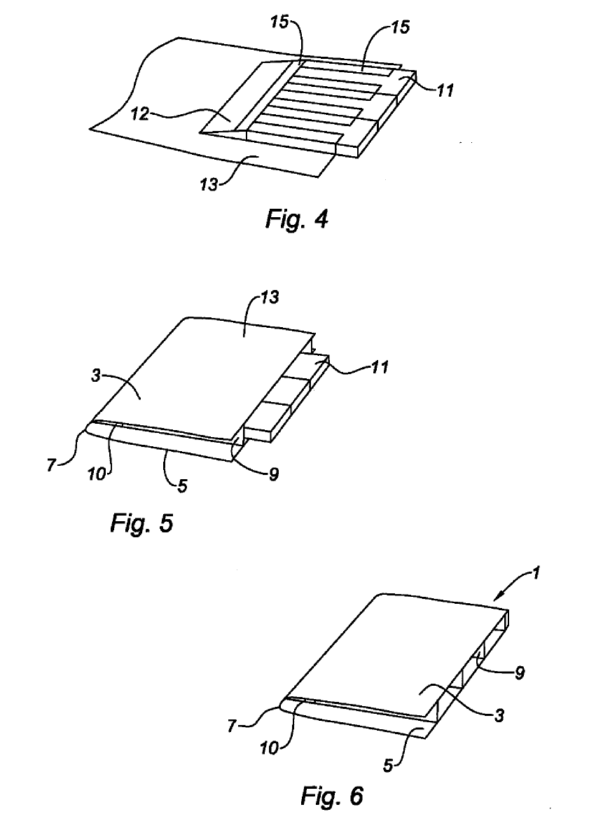

Furthermore, according to the invention, the panel 1 according to the invention is obtained using a manufacturing method comprising:
a first step (A) in which first cores 11 and at least one second core 12 are positioned, each surrounded at least partially by a draping skin 15, on a base skin 13, in two non-collinear directions Δ₁₀ and Δ₉, in particular respectively over a length and a width of said base skin 13, such that the latter can be folded on itself (see FIG. 4);
a second step B in which the base skin 13 is folded on the first 11 and second 12 draped cores (FIG. 5);
a third step C in which the panel thus obtained is polymerized so as to integrate the plies of the draping into the base skin 13 to form the transverse stiffeners 9 and/or the longitudinal spar(s) 10; and
a fourth step D in which the first cores 11 and the second core(s) 12 are removed so as to obtain the structural panel (see FIG. 6).

Hereafter, the expressions “at least partially surrounded” and “draped” are synonymous. Thus, the term “draping” designates at least partially surrounding a core

Owing to the inventive method, it is possible to adjust the number of plies between two transverse stiffeners 9 and at the spar(s) 10. It is then possible to optimize the mass of the panel 1 according to the invention while guaranteeing a significant longitudinal and transverse stiffness.

Furthermore, owing to the method according to the invention, the panel 1 is formed in a single piece by fusing the base skin 13 folded on itself and the draping skin.

Furthermore, the method makes it possible to insert the desired number of stiffeners and spar(s) as a function of the desired structural strength by increasing or decreasing the number of cores or the dimensions thereof.

Furthermore, the method does not impose any constraints as to the positioning of the stiffeners and that of the spar(s). The latter are placed so as to improve their structural utility.

More particularly, in step A, the first cores 11 are each at least partially surrounded by a draping skin 15 on the lateral sides of said cores 11.

The second core(s) 12 are each at least partially surrounded by a draping skin 15 on at least part of a longitudinal side of said cores 12.

The first cores 11 and the second core(s) 12 used have an appropriate shape to form the transverse stiffeners 9 as well as the spar(s) 10. To that end, they typically have a transverse cross-section that is substantially triangular, rectangular, square, or even trapezoidal.

Typically, first cores 11 making it possible to form the transverse stiffeners 9 are arranged before the edge 7 so as to form a space in which one or more second core(s) 12 are installed parallel to the edge 7, making it possible to form the spar(s) 10 (see FIG. 4).

Advantageously, the first cores 11 have a height decreasing along the length of said first cores 11 so as to fit the small curve radius of the edge 7.

Furthermore, the second core(s) 12 have a transverse section with a decreasing height over the transverse section of said second core(s) 12 so as to fit the small curve radius of the edge 7. In this way, it is possible to have an excellent aerodynamic profile of the structural panel 1.

Advantageously, the first 11 and second 12 cores are placed on the base skin 13 over a length thereof appropriate to make it possible to fold the base skin 13 on itself. In this way, the first 11 and second 12 cores can be placed over a distance smaller than half the length of said skin 13, which makes it possible to have an upper surface 3 with a length substantially equal to that of the lower surface 5.

The draping is typically done before placement of the first cores 11 and the second core(s) 12 on the base skin 13. The draping is then done by a monolithic draping skin 15 having a plurality of plies, for example two or three plies so as to obtain optimum draping. Typically, the draping skin 15 comprises a number of plies smaller than that of the base skin 13.

The base skin 13 can include a number of plies greater than 2, equal to 3, 5 or more.

The draping skin 15 can include a number of plies greater than 2, equal to 3, 5 or more.

The plies of the base skin 13 and the draping skin 15 are impregnated with polymerizable resin such as epoxy resin.

In step B, the base skin 13 is folded on itself using any means known by those skilled in the art so as to form an edge 7, an upper surface 3, and a lower surface 5. This makes it possible to produce, in a single operation and simply, a structural trailing edge panel in which the trailing edge is made in the same operation as the upper and lower surfaces and while ensuring structural continuity between those three elements.

The production of a structural trailing edge panel in which it is then necessary to perform the structural connection between the upper and lower surfaces by an attached trailing edge makes the method for manufacturing a structural panel more complex.

Typically, the polymerization of step C is done by heating at a curing temperature. The curing temperature depends on the type of resin used to produce the integral panel 1 of the invention. As an example, if the base 13 and/or draping skin 15 is (are) made with epoxy resin, the curing temperature is comprised between 60° C. and 200° C.

This step is typically done in an autoclave or any heating means.

Typically, the base skin 13 and the draping skin 15 include fiber-based plies, for example using glass fibers, carbon fibers, and Kevlar fibers, said fibers being impregnated with polymerizable resin during curing of the material.

In step D, the first cores 11 and the second core(s) 12 are removed from the panel thus formed using any means known by those skilled in the art, in particular by extractors handled manually or automatically. The removal of the cores 11 and 12 is typically done in a direction substantially collinear to the direction assumed by the transverse stiffeners 9 or the spar(s) 10, if applicable.

The panel 1 according to the invention can advantageously be used in an aircraft element, such as an airplane control surface.

1. A method for manufacturing a composite trailing edge panel for an aircraft element, comprising:
a first step in which first cores and at least one second core are positioned, each surrounded at least partially by a draping skin on a base skin, in two non-collinear directions, such that said base skin can be folded on itself;
a second step in which the base skin is folded on the first and second draped cores;
a third step in which the panel thus obtained is polymerized so as to integrate the plies of the draping into the base skin to form the transverse stiffeners and a longitudinal spar(s); and
a fourth step in which the first cores and the second core(s) are removed so as to obtain the structural panel.

2. The method according to claim 1, wherein the directrix of each longitudinal spar and the directrix of the transverse stiffeners are substantially perpendicular.

3. The method according to claim 1, wherein at least one longitudinal spar is positioned between two transverse stiffeners.

4. The method according to claim 1, wherein the skin forming said panel comprises a plurality of plies, including one or more inner plies forming the longitudinal spar(s).

5. The method according to claim 1, wherein the panel comprises reinforcing plies between the inner plies.

6. The method according to claim 1, wherein the second core(s) have a decreasing height along a transverse section of said cores.

7. The method according to claim 1, wherein each first and second core is draped by a draping skin of the monolithic type having a plurality of plies.

8. The method according to claim 1, wherein, in step A, first cores are positioned before the trailing edge so as to form a space between the trailing edge and the first cores, in which space one or more second cores are installed substantially parallel to the trailing edge.

9. An aircraft element comprising at least one structural panel obtained according to claim 1.

10. The element according to claim 9 being an airplane control surface.
